(19) United States
(12) Patent Application Publication
(10) Pub. No.: US 2011/0251937 A1
(43) Pub. Date: Oct. 13, 2011

(54) SOFTWARE LICENSE BROKERING WITHIN A CLOUD COMPUTING ENVIRONMENT

(75) Inventors: Walter Falk, Austin, TX (US); Donald W. Thomas, Austin, TX (US)

(73) Assignee: International Business Machines Corporation, Armonk, NY (US)

(21) Appl. No.: 12/757,110

(22) Filed: Apr. 9, 2010

(51) Int. Cl. G06Q 30/00; G06Q 10/00; G06F 21/00

(52) U.S. Cl. 705/34; 726/26

(57) ABSTRACT

Under embodiments of the present invention, a set (at least one) of Clouds, a set of software providers, and a set of Cloud consumers (hereinafter “consumers”) are registered with a Cloud software license broker (hereinafter “broker”). Consumer information will be matched with the set of software providers to determine applicable licenses as well as pricing and usage rates. Use of software within the set of Clouds by the set of Cloud consumers will be tracked, aggregated, and reported. Based on the use, a licensing arrangement (including a price) will be determined. Applicable amounts will then be billed, and payments will be collected and disbursed (e.g., to the set of software providers) in accordance with the licensing arrangements. Under the present invention, prices/amounts can be determined based on a per use/on-demand of software and/or based on use of the software over an interval of time (e.g., interval-based pricing).

### TECHNICAL FIELD

The present invention generally relates to Cloud computing. Specifically, the present invention relates to software license brokering within a Cloud computing environment.

### BACKGROUND

The Cloud computing environment is an enhancement to the predecessor grid environment, whereby multiple grids and other computation resources may be further abstracted by a Cloud layer, thus making disparate devices appear to an end-user as a single pool of seamless resources. These resources may include such things as physical or logical compute engines, servers and devices, device memory, storage devices, networks, business applications and other software, and the like.

Cloud computing and associated Cloud services are now widely available and becoming a standard services delivery mechanism for businesses of all sizes. In order to control and administer software at all layers of the Cloud stack, there is a requirement for many companies for that software to have an associated license: operating systems; middleware; databases; virtualization; and/or applications. Each of these software products operate on various levels within the Cloud architecture stack. The issue of license management in a Cloud environment is a gradually maturing area in which many challenges still exist that are not adequately addressed by current solutions.

### SUMMARY

Embodiments of the present invention provide a Cloud License Broker that that can act as an intermediary between various Clouds, providers/vendors, and end-users (consumers). The Cloud license broker will connect users (consumers) and vendors (companies) to allow for flexible access to software at all layers of the Cloud software stack, incorporating (among others): authentication and authorization with regard to the software being used; on-demand and/or pre-arranged software access for an end-user/consumer; accounting, metering, and billing that incorporates flexible discount agreements between consumers and vendors; etc. Since the software stack in a Cloud environment is most often made up of software from many vendors, the combined license management solution discussed herein takes into account how these vendors each monitor their individual license requirements and associated accounting or metering of the software and the billing requirements. In general, embodiments of the invention are based on a license broker for the Cloud, which will resolve the issues described above with a single integrated solution within a multi-vendor environment and across multiple interconnected Clouds (public, private and hybrid).

Specifically, under embodiments of the present invention, a set (at least one) of Clouds, a set of software providers, and a set of Cloud consumers (hereinafter “consumers”) are registered with a Cloud software license broker (hereinafter “broker”). Consumer information will be matched with the set of software providers to determine applicable licenses as well as pricing and usage rates. Use of software within the set of Clouds by the set of Cloud consumers will be tracked, aggregated, and reported. Based on the use, a licensing arrangement (including a price) will be determined. Applicable amounts will then be billed, and payments will be collected and disbursed (e.g., to the set of software providers) in accordance with the licensing arrangements for each software product. Under the present invention, prices/amounts can be determined based on a per-use or on-demand usage of software and/or based on use of the software over an interval of time (e.g., interval-based pricing).

A first aspect of the present invention provides a method for licensing software within a Cloud computing environment, comprising: registering a set of Clouds and a set of software providers to provide software for use via the set of Clouds; tracking a use of the software within the Cloud computing environment by a Cloud consumer; aggregating and reporting the use; and determining a licensing arrangement based on the use, the licensing arrangement comprising a price for the use of the software.

A second aspect of the present invention provides a system for licensing software within a Cloud computing environment, comprising: a memory medium comprising instructions; a bus coupled to the memory medium; a processor coupled to the bus that when executing the instructions causes the system to: register a set of Clouds and a set of software providers to provide software for use via the set of Clouds; track a use of the software within the Cloud computing environment by a Cloud consumer; aggregate and report the use; and determine a licensing arrangement based on the use, the licensing arrangement comprising a price for the use of the software.

A third aspect of the present invention provides a computer readable medium containing a program product for licensing software within a Cloud computing environment, the computer readable medium comprising program code for causing a computer to: register a set of Clouds and a set of software providers to provide software for use via the set of Clouds; track a use of the software within the Cloud computing environment by a Cloud consumer; aggregate and report the use; and determine a licensing arrangement based on the use, the licensing arrangement comprising a price for the use of the software.

A fourth aspect of the present invention provides a method for deploying a system for licensing software within a Cloud computing environment, comprising: providing a computer infrastructure being operable to: register a set of Clouds and a set of software providers to provide software for use via the set of Clouds; track a use of the software within the Cloud computing environment by a Cloud consumer; aggregate and report the use; and determine a licensing arrangement based on the use, the licensing arrangement comprising a price for the use of the software.

### BRIEF DESCRIPTION OF THE INVENTION

These and other features of this invention will be more readily understood from the following detailed description of the various aspects of the invention taken in conjunction with the accompanying drawings in which:

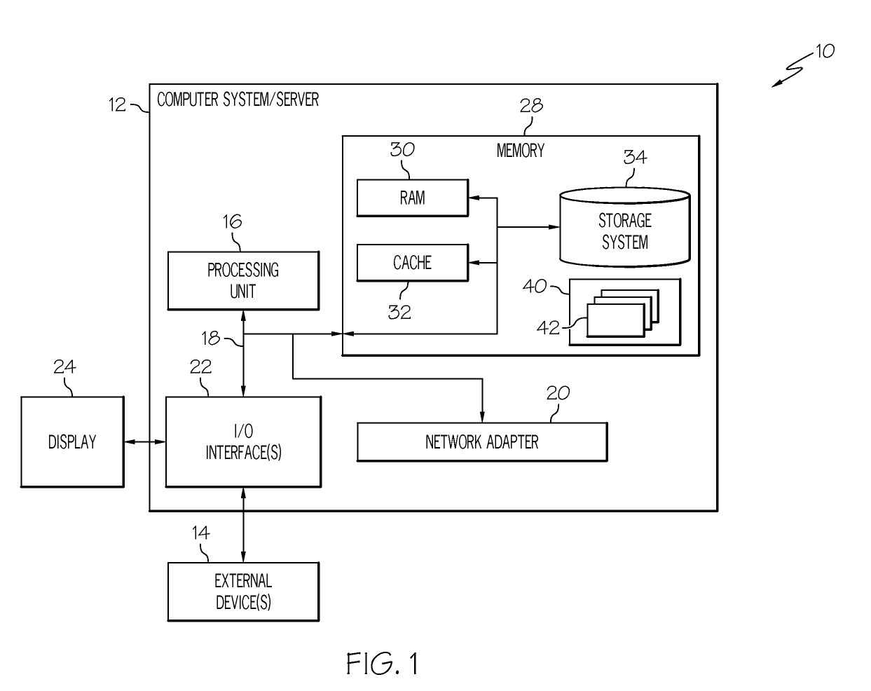

FIG. 1 depicts a Cloud computing node according to an embodiment of the present invention.

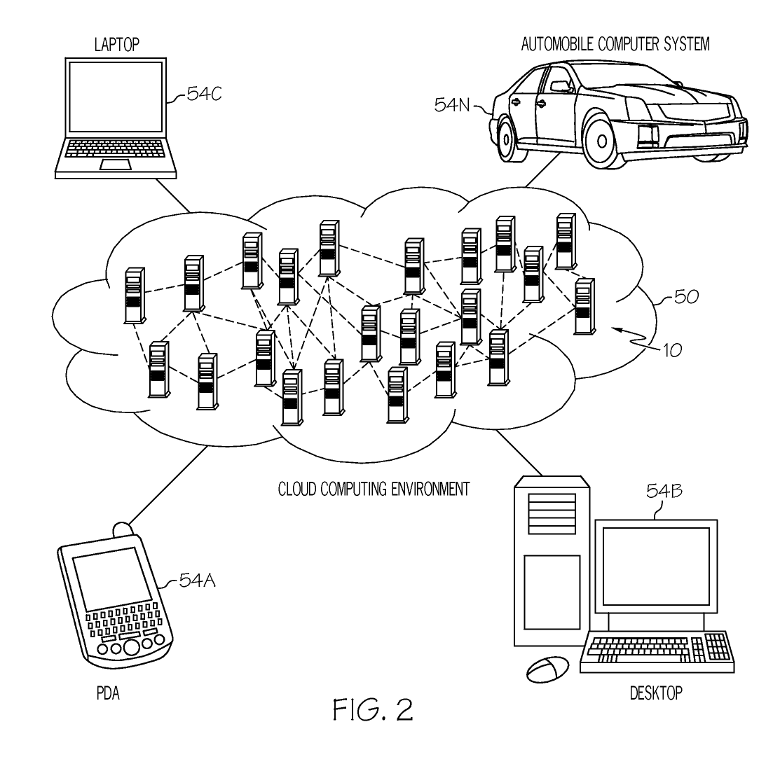

FIG. 2 depicts a Cloud computing environment according to an embodiment of the present invention.

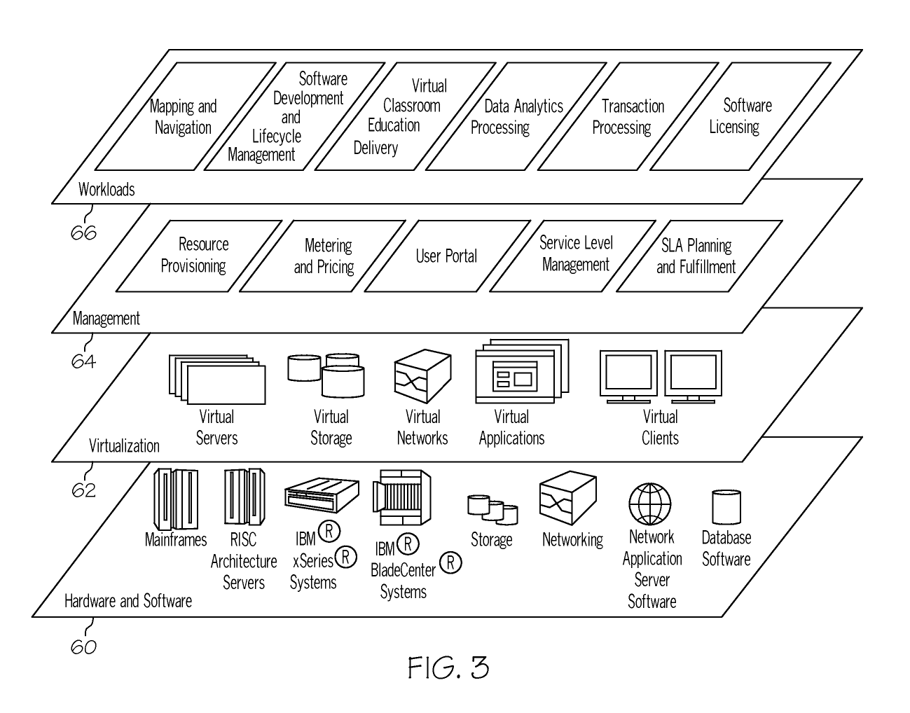

FIG. 3 depicts Cloud abstraction model layers according to an embodiment of the present invention.

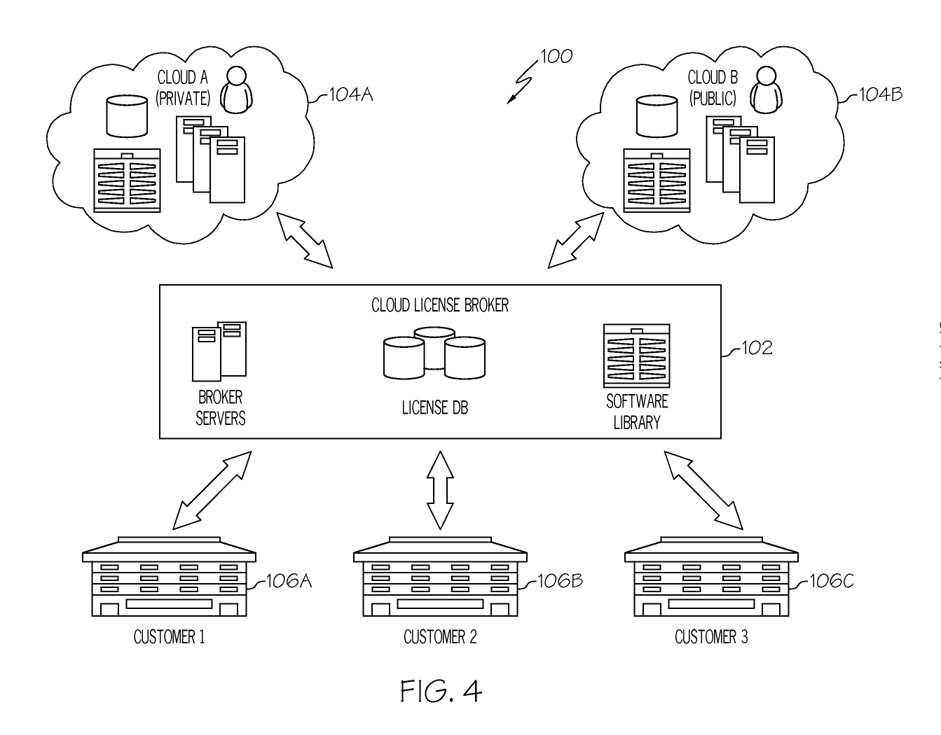

FIG. 4 depicts a system for licensing software within a Cloud computing environment according to an embodiment of the present invention.

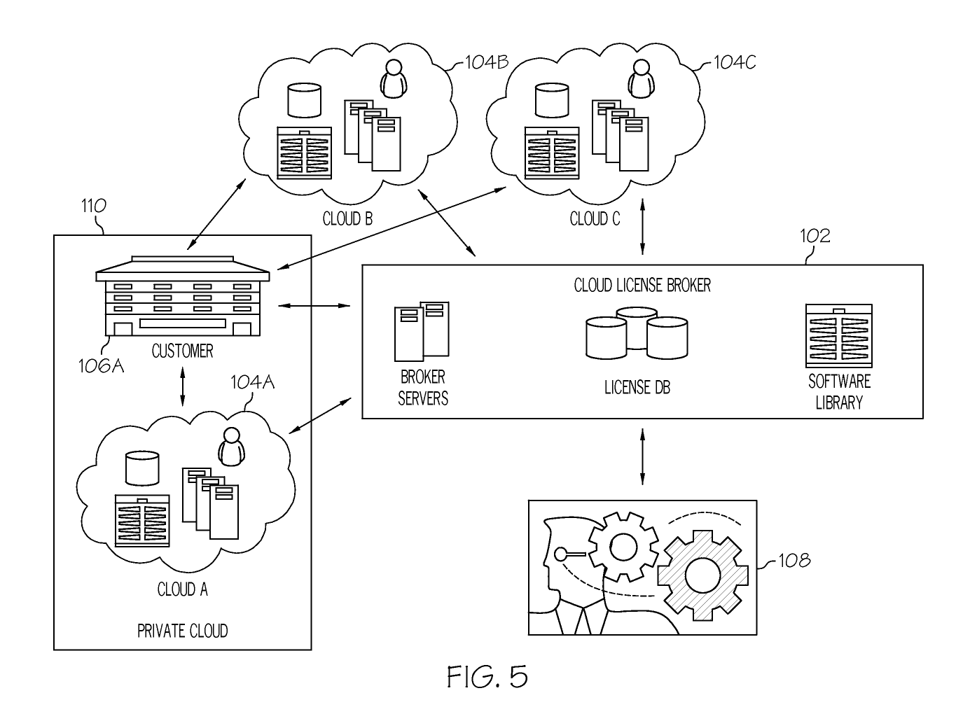

FIG. 5 depicts a diagram of an illustrative licensing transaction scenario according to an embodiment of the present invention.

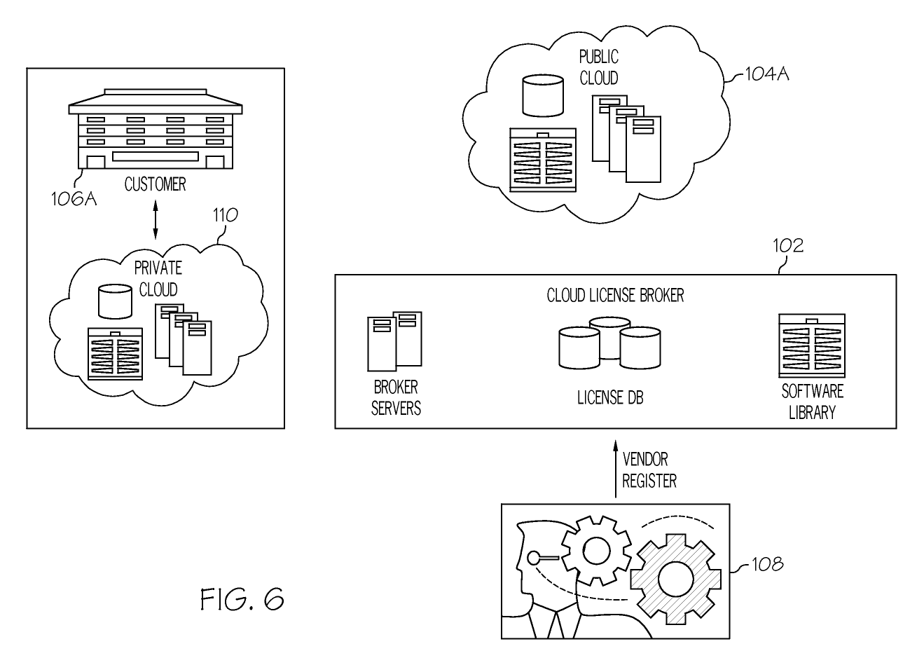

FIG. 6 depicts a first diagram of an illustrative use case according to an embodiment of the present invention.

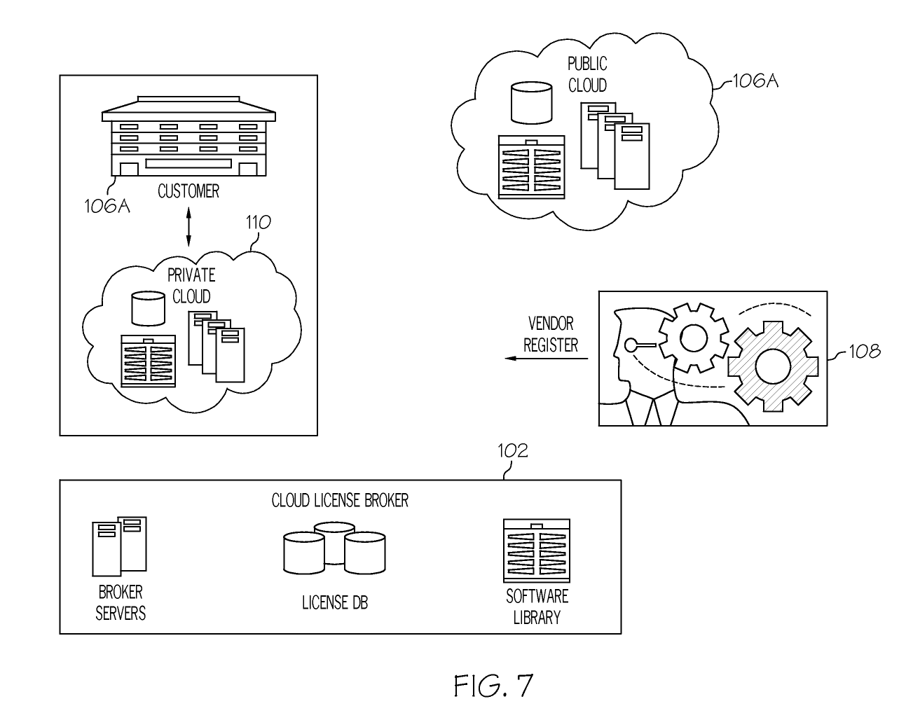

FIG. 7 depicts a second diagram of an illustrative use case according to an embodiment of the present invention.

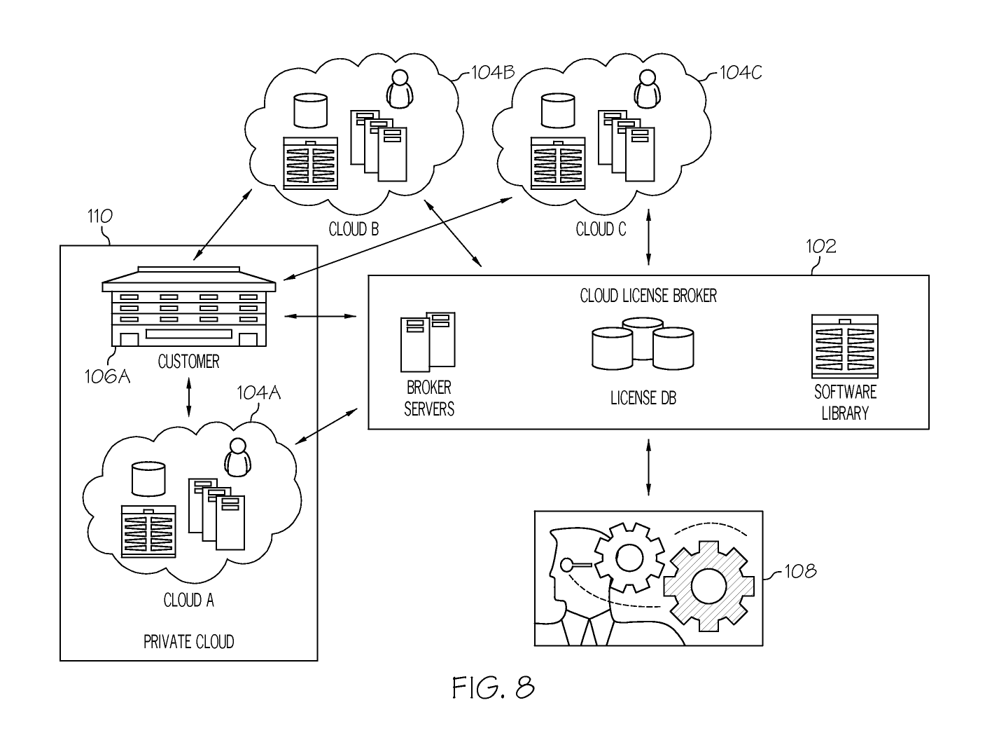

FIG. 8 depicts a third diagram of an illustrative use case according to an embodiment of the present invention.

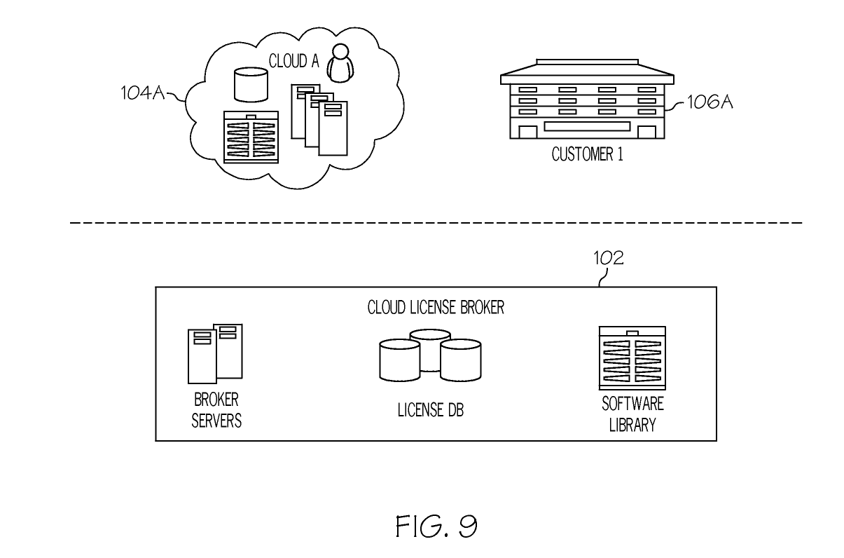

FIG. 9 depicts a diagram of an illustrative implementation according to an embodiment of the present invention.

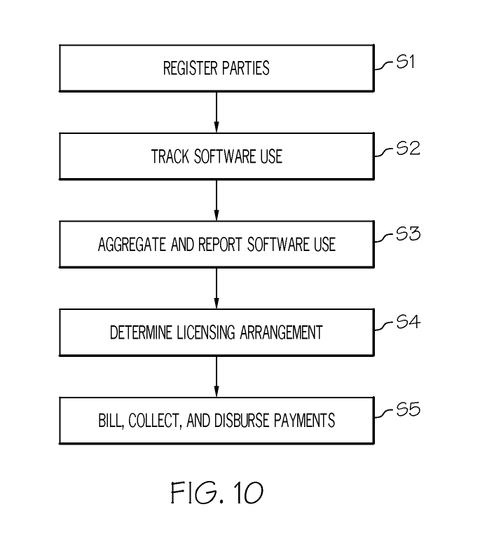

FIG. 10 depicts a method flow diagram according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

For convenience, the Detailed Description has the following sections:
I. Cloud Computing Definitions
II. Detailed Implementation of Embodiments of the Invention

### I. Cloud Computing Definitions

The following definitions have been derived from the “Draft NIST Working Definition of Cloud Computing” by Peter Mell and Tim Grance, dated Oct. 7, 2009, which is cited on an IDS filed herewith, and a copy of which is attached thereto.

Cloud computing is a model for enabling convenient, on-demand network access to a shared pool of configurable computing resources (e.g., networks, servers, storage, applications, and services) that can be rapidly provisioned and released with minimal management effort or service provider interaction. This Cloud model promotes availability and is comprised of at least five characteristics, at least three service models, and at least four deployment models.

Characteristics are as follows:

On-demand self-service: A consumer can unilaterally provision computing capabilities, such as server time and network storage, as needed, automatically without requiring human interaction with each service's provider.

Broad network access: Capabilities are available over a network and accessed through standard mechanisms that promote use by heterogeneous thin or thick client platforms (e.g., mobile phones, laptops, and PDAs).

Resource pooling: The provider's computing resources are pooled to serve multiple consumers using a multi-tenant model, with different physical and virtual resources dynamically assigned and reassigned according to consumer demand. There is a sense of location independence in that the consumer generally has no control or knowledge over the exact location of the provided resources but may be able to specify location at a higher level of abstraction (e.g., country, state, or datacenter). Examples of resources include storage, processing, memory, network bandwidth, and virtual machines.

Rapid elasticity: Capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: Cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Cloud Software as a Service (SaaS): The capability provided to the consumer is to use the provider's applications running on a Cloud infrastructure. The applications are accessible from various client devices through a thin client interface such as a web browser (e.g., web-based e-mail). The consumer does not manage or control the underlying Cloud infrastructure including network, servers, operating systems, storage, or even individual application capabilities, with the possible exception of limited user-specific application configuration settings.

Cloud Platform as a Service (PaaS): The capability provided to the consumer is to deploy onto the Cloud infrastructure consumer-created or acquired applications created using programming languages and tools supported by the provider. The consumer does not manage or control the underlying Cloud infrastructure including networks, servers, operating systems, or storage, but has control over the deployed applications and possibly application hosting environment configurations.

Cloud Infrastructure as a Service (IaaS): The capability provided to the consumer is to provision processing, storage, networks, and other fundamental computing resources where the consumer is able to deploy and run arbitrary software, which can include operating systems and applications. The consumer does not manage or control the underlying Cloud infrastructure but has control over operating systems, storage, deployed applications, and possibly limited control of select networking components (e.g., host firewalls).

Deployment Models are as follows:

Private Cloud: The Cloud infrastructure is operated solely for an organization. It may be managed by the organization or a third party and may exist on-premises or off-premises.

Community Cloud: The Cloud infrastructure is shared by several organizations and supports a specific community that has shared concerns (e.g., mission, security requirements, policy, and compliance considerations). It may be managed by the organizations or a third party and may exist on-premises or off-premises.

Public Cloud: The Cloud infrastructure is made available to the general public or a large industry group and is owned by an organization selling Cloud services.

Hybrid Cloud: The Cloud infrastructure is a composition of two or more Clouds (private, community, or public) that remain unique entities but are bound together by standardized or proprietary technology that enables data and application portability (e.g., Cloud bursting for load-balancing between Clouds).

A Cloud computing environment is service oriented with a focus on statelessness, low coupling, modularity, and semantic interoperability.

### II. Detailed Implementation of Embodiments of the Invention

As indicated above, embodiments of the present invention provide a Cloud License Broker that can act as an intermediary between various Clouds, vendors, and end-users (consumers). The Cloud license broker will connect users (consumers) and vendors (companies) to allow for flexible access to software at all layers of the Cloud software stack, incorporating (among other): authentication and authorization with regard to the software being used; on-demand and/or pre-arranged software access for an end-user; accounting, metering, and billing that incorporates flexible discount agreements between consumers and vendors; etc. Since the software stack in a Cloud environment is most often made up of software from many vendors, the combined license management solution discussed herein takes into account how these vendors each monitor their individual license requirements and associated accounting or metering of the software and the billing requirements. In general, embodiments of the invention are based on a license broker for the Cloud, which will resolve the issues described above with a single integrated solution within a multi-vendor environment and across multiple interconnected Clouds (public, private, and hybrid).

Specifically, under embodiments of the present invention, a set (at least one) of Clouds, a set of software providers, and a set of Cloud consumers (hereinafter “consumers”) are registered with a Cloud software license broker (hereinafter “broker”). Consumer information will be matched with the set of software providers to determine applicable licenses as well as pricing and usage rates. Use of software within the set of Clouds by the set of Cloud consumers will be tracked, aggregated and reported. Based on the use, a licensing arrangement (including a price) will be determined. Applicable amounts will then be billed, and payments will be collected and disbursed (e.g., to the set of software providers) in accordance with the licensing arrangements. Under the present invention, prices/amounts can be determined based on a per use/on-demand of software and/or based on use of the software over an interval of time (e.g., interval-based pricing).

Referring now to FIG. 1, a schematic of an exemplary Cloud computing node is shown. Cloud computing node 10 is only one example of a suitable Cloud computing node and is not intended to suggest any limitation as to the scope of use or functionality of the invention described herein. Regardless, Cloud computing node 10 is capable of being implemented and/or performing any of the functions set forth in Section I above.

In Cloud computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed Cloud computing environments that include any of the above systems or devices, and the like.

Computer system/server 12 may be described in the general context of computer system-executable instructions, such as program modules, being executed by a computer system. Generally, program modules include routines, programs, objects, components, logic, data structures, and so on, that perform particular tasks or implement particular abstract data types. The exemplary computer system/server 12 may be practiced in distributed Cloud computing environments where tasks are performed by remote processing devices that are linked through a communications network. In a distributed Cloud computing environment, program modules may be located in both local and remote computer system storage media including memory storage devices.

As shown in FIG. 1, computer system/server 12 in Cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of the invention.

The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, radio-frequency (RF), etc., or any suitable combination of the foregoing.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of the invention as described herein.

Computer system/server 12 may also communicate with one or more external devices 14 such as a keyboard, a pointing device, a display 24, etc., one or more devices that enable a user to interact with computer system/server 12, and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

Referring now to FIG. 2, illustrative Cloud computing environment 50 is depicted. As shown, Cloud computing environment 50 comprises one or more Cloud computing nodes 10 with which computing devices such as, for example, personal digital assistant (PDA) or cellular telephone 54A, desktop computer 54B, laptop computer 54C, and/or automobile computer system 54N communicate. This allows for infrastructure, platforms, and/or software to be offered as services (as described above in Section I) from Cloud computing environment 50 so as to not require each client to separately maintain such resources. It is understood that the types of computing devices 54A-N shown in FIG. 2 are intended to be illustrative only and that Cloud computing environment 50 can communicate with any type of computerized device over any type of network and/or network/addressable connection (e.g., using a web browser).

Referring now to FIG. 3, a set of functional abstraction layers provided by Cloud computing environment 50 (FIG. 2) is shown. It should be understood in advance that the components, layers, and functions shown in FIG. 3 are intended to be illustrative only, and the invention is not limited thereto. As depicted, the following layers and corresponding functions are provided:

Hardware and software layer 60 includes hardware and software components. Examples of hardware components include mainframes. In one example: IBM® zSeries® systems and RISC (Reduced Instruction Set Computer) architecture based servers. In one example, IBM pSeries® systems, IBM xSeries® systems, IBM BladeCenter® systems, storage devices, networks, and networking components. Examples of software components include network application server software. In one example, IBM WebSphere® application server software and database software. In one example, IBM DB2® database software. (IBM, zSeries, pSeries, xSeries, BladeCenter, WebSphere, and DB2 are trademarks of International Business Machines Corporation in the United States, other countries, or both.)

Virtualization layer 62 provides an abstraction layer from which the following exemplary virtual entities may be provided: virtual servers; virtual storage; virtual networks, including virtual private networks; virtual applications; and virtual clients.

Management layer 64 provides the exemplary functions described below. Resource provisioning provides dynamic procurement of computing resources and other resources that are utilized to perform tasks within the Cloud computing environment. Metering and pricing provide cost tracking as resources are utilized within the Cloud computing environment, and billing or invoicing for consumption of these resources. In one example, these resources may comprise application software licenses. Security provides identity verification for users and tasks, as well as protection for data and other resources. User portal provides access to the Cloud computing environment for both users and system administrators. Service level management provides Cloud computing resource allocation and management such that required service levels are met. Service Level Agreement (SLA) planning and fulfillment provides pre-arrangement for, and procurement of, Cloud computing resources for which a future requirement is anticipated in accordance with an SLA.

Workloads layer 66 provides functionality for which the Cloud computing environment is utilized. Examples of workloads and functions which may be provided from this layer include: mapping and navigation; software development and lifecycle management; virtual classroom education delivery; data analytics processing; transaction processing; and software licensing. As mentioned above, all of the foregoing examples described with respect to FIG. 3 are illustrative only, and the invention is not limited to these examples.

It is understood all functions of the present invention as described herein are typically performed by the software licensing function, which can be tangibly embodied as modules of program code 42 of program/utility 40 (FIG. 1). This can be implemented within the cloud environment 50 or as a third party (external) broker that interfaces with one or more clouds (as will be further described below).

Referring now to FIG. 4, a system 100 for licensing software within a Cloud computing environment 50 (FIG. 2) is shown. As depicted, system 10 generally comprises a Cloud license broker (hereinafter “broker 102”) that communicates with a set of Clouds 104A-B and a set of Cloud consumers 106A-C. Although not shown in FIG. 4, broker 102 will also communicate with a set of software providers. Regardless, broker 102 will comprise various pieces of infrastructure and/or resources such as servers, databases, and/or libraries. These resources will be used to store information for providing the functionality recited herein (e.g., catalogues of software available via Clouds 104A-B, license agreements, registration information, etc.). In general, broker 102 coordinates and manages the licensing of software provided by vendor(s)/provider(s) as used via Clouds 104A-B by consumers 106A-C. In general broker can comprise one or more computer systems such as computer system 12 shown in FIG. 1. Along these lines set of modules 42 of program code 40 can be a software licensing brokering program enables the functionality of the present invention. More specifically, broker 102 acts as a trusted connection point between Clouds, consumers, and software providers and provides the following functions (among others):

Secure Access, Authentication and Authorization
Access—secure access via sockets
Authentication—authenticated access for consumers 106A-C and software providers
Authorization—tracks consumer 106A-C authorization. Authorization techniques can use current license key scheme supported by software providers or master consumer agreement numbers.

Vendor Registration
Software providers can register with broker 102
Access credentials and financial transaction data
Register software package and rate information.

Consumer Registration
Consumers can register with broker 102
Access credentials and financial transaction data

Software provider<->Consumer Agreements
Details on software packages, rates, discount levels, volumes, etc

Software Library

Broker 102 can also catalogue software for access by consumers 106A-C

Broker 102 provides requested software to consumer's 106A-C Cloud service provider on-demand

Along these lines, broker 102 would act as a third-party intermediary between the Clouds, software providers, and consumers. It is also possible to install the broker 102 within a private Cloud as a standard component that does not have outside-the-firewall Cloud providers.

Referring now to FIG. 5, an illustrative licensing transaction scenario from a consumer's point of view is shown. Under this scenario, the following actions will take place:
1. Clouds 104A-C register with broker 102.
2. Software providers/vendors 108 register with broker 102.
3. Consumer 106A uses his own private Cloud 110 for services, this is tracked and communicated to broker 102.
4. Consumer 106A accesses services in Cloud 104B and Cloud 104C, the license usage within accessed services is also tracked by broker 102.
5. At the end of the defined reporting period, broker 102 can aggregate all license usage by vendor and product and report it to consumer 106A and software provider 108.
6. This allows on-demand access of licenses across software provider 108, but allows consumer 106A to leverage volume agreements with software providers.

These concepts are further shown and described in conjunction with the use case depicted in FIGS. 6-8. In this illustrative use case, broker 102 is a third party with respect to either consumer 106A or software provider 108.
1. Set up (FIGS. 6-7)

a. A software provider 108 registers with broker 102, providing access credentials and financial transaction information.

b. Software provider 108 registers individual software packages with broker 102. Each package contains license, authorization, authentication, and pricing information, which will be managed by broker 102.

c. Software provider 108 specifies ad hoc pricing that can be used by “walk up” consumer 106As.

d. Software provider 108 registers its initial consumer 106A list, which includes license keys and rates, including volume discount information.

e. Consumer 106A registers with broker 102, providing access credentials and financial billing information.

f. Software providers register with broker 102.

g. Consumer registers with a private Cloud, for “walk up” use, no pre-registration may be necessary.

h. The broker 102 matches up consumer 106A information with all software providers 108 with which consumer 106A has agreements.
2. Usage (FIG. 8)

a. Consumer 106A starts using Cloud services from one or more of the software provider 108s. In each case, the Cloud connects to broker 102 to get software usage rates.

b. The Cloud reports usage rates to broker 102 on a defined interval per policy by software provider 108 requirements.

c. Broker 102 tracks usage and rates from all Clouds, public and private.

d. Consumer 106A is billed on a defined interval, specified by the service agreement with such consumer.

END920100016US1 Page 24 of 37

e. Software provider 108 is paid on a defined interval, as specified by the payment policy between the Cloud software provider 108 and the software provider 108.

Referring now to FIG. 9, an illustrative implementation of broker 102 is shown. As depicted, broker 102 can be implemented as a standard web services application that includes:

Web Application Server software such as IBM® Websphere® web application server software (IBM, Websphere, DB2, and related terms are trademarks of IBM Corporation in the United States and/or other countries).

Database software such as IBM® DB2® database software may be used to track all metadata.

Portal software such as IBM® Websphere Portal® software for consumers 106A to obtain data and reports. Along these lines, the following license models could be supported:
1. Permanent seat licensing.
2. Micro-licensing based on fixed durations, like hourly, daily, etc.
3. Concurrent licensing.
4. On Demand Licensing (walk-up licensing and similar models).

These models essentially connect the software providers directly with the consumers. The Cloud provider does not have to pre-purchase licenses as part of their business model. The provider can make licenses available for usage with no parties incurring a risk. This will encourage Cloud resource availability, which will result in provider and consumer benefits. If licensing interoperability becomes a standard, this will reduce costs for providers and consumers.

These functions are summarized in the method flow diagram of FIG. 10. As depicted, in step S1, parties (e.g., Clouds, consumers, and/or software providers) are registered. In step S2, a use of software within the Cloud computing environment is tracked. In step S3, this use is aggregated and reports so that a licensing agreement and/or arrangement can be determined/developed in step S4. In one or more subsequent steps (shown collectively as step S5), payments due can be billed, collected, and disbursed according to the licensing arrangement.

While shown and described herein as a software licensing brokering solution for a Cloud computing environment, it is understood that the invention further provides various alternative embodiments. For example, in one embodiment, the invention provides a computer-readable/useable medium that includes computer program code to enable a computer infrastructure to provide software license brokering functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide software license brokering. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for providing software license brokering functionality. In this case, a computer infrastructure, such as computer system 12 (FIG. 1), can be provided, and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1) from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A method for licensing software within a Cloud computing environment, comprising:
registering a set of Clouds and a set of software providers to provide software for use via the set of Clouds;
tracking a use of the software within the Cloud computing environment by a Cloud consumer;
aggregating and reporting the use; and
determining a licensing arrangement based on the use, the licensing arrangement comprising a price for the use of the software.

2. The method of claim 1, further comprising billing the Cloud consumer based on the licensing arrangement.

3. The method of claim 1, further comprising:
collecting a payment from the Cloud consumer based on the licensing arrangement; and
disbursing the payment to the set of software providers.

4. The method of claim 1, further comprising collecting use and rate information from the set of software providers, the licensing arrangement being based on the use and rate information.

5. The method of claim 1, the price being based on at least one of the following: on-demand use of the software, or interval-based use of the software.

6. The method of claim 1, further comprising registering the Cloud consumer.

7. The method of claim 1, further comprising matching information associated with the Cloud consumer with the set of software providers.

8. A system for licensing software within a Cloud computing environment, comprising:
a memory medium comprising instructions;
a bus coupled to the memory medium;
a processor coupled to the bus that when executing the instructions causes the system to:
register a set of Clouds and a set of software providers to provide software for use via the set of Clouds;
track a use of the software within the Cloud computing environment by a Cloud consumer;
aggregate and report the use; and
determine a licensing arrangement based on the use, the licensing arrangement comprising a price for the use of the software.

9. The system of claim 8, the system further being caused to bill the Cloud consumer based on the licensing arrangement.

10. The system of claim 8, the system further being caused to:
collect a payment from the Cloud consumer based on the licensing arrangement; and
disburse the payment to the set of software providers.

11. The system of claim 8, the system further being caused to collect use and rate information from the set of software providers, the licensing arrangement being based on the use and rate information.

12. The system of claim 8, the price being based on at least one of the following: on-demand use of the software, or interval-based use of the software.

13. The system of claim 8, the system further being caused to register the Cloud consumer.

14. The system of claim 8, the system further being caused to match information associated with the Cloud consumer with the set of software providers.

15. A computer readable medium containing a program product for licensing software within a Cloud computing environment, the computer readable medium comprising program code for causing a computer to:
register a set of Clouds and a set of software providers to provide software for use via the set of Clouds;
track a use of the software within the Cloud computing environment by a Cloud consumer;
aggregate and report the use; and
determine a licensing arrangement based on the use, the licensing arrangement comprising a price for the use of the software.

16. The computer readable medium containing the program product of claim 15, the computer further being caused to bill the Cloud consumer based on the licensing arrangement.

17. The computer readable medium containing the program product of claim 15, the computer further being caused to:
collect a payment from the Cloud consumer based on the licensing arrangement; and
disburse the payment to the set of software providers.

18. The computer readable medium containing the program product of claim 15, the computer further being caused to collect use and rate information from the set of software providers, the licensing arrangement being based on the use and rate information.

19. The computer readable medium containing the program product of claim 15, the price being based on at least one of the following: on-demand use of the software, or interval-based use of the software.

20. The computer readable medium containing the program product of claim 15, the computer further being caused to register the Cloud consumer.

21. The computer readable medium containing the program product of claim 15, the computer further being caused to match information associated with the Cloud consumer with the set of software providers.

22. A method for deploying a system for licensing software within a Cloud computing environment, comprising:
providing a computer infrastructure being operable to:
register a set of Clouds and a set of software providers to provide software for use via the set of Clouds;
track a use of the software within the Cloud computing environment by a Cloud consumer;
aggregate and report the use; and
determine a licensing arrangement based on the use, the licensing arrangement comprising a price for the use of the software.
